(19) United States
(12) Patent Application Publication
(10) Pub. No.: US 2007/0228586 A1
(43) Pub. Date: Oct. 4, 2007

(54) Process for making an optical film

(76) Inventors: William Ward Merrill, White Bear Lake, MN (US); Andrew J. Ouderkirk, Woodbury, MN (US); Matthew B. Johnson, St. Paul, MN (US); Timothy J. Hebrink, Scandia, MN (US); Martin E. Denker, Vadnais Heights, MN (US); Mark B. O'Neill, Stillwater, MN (US)

Correspondence Address: 3M INNOVATIVE PROPERTIES COMPANY, PO BOX 33427, ST. PAUL, MN, 55133-3427, US

(21) Appl. No.: 11/394,479

(22) Filed: Mar. 31, 2006

(51) Int. Cl. B29D 11/00

(52) U.S. Cl. 264/1.34; 264/2.7; 264/1.7

(57) ABSTRACT

Exemplary methods include includes providing a film comprising at least one polymeric material; widening the film under a first set of processing conditions in a first draw step along the crossweb direction such that in-plane birefringence, if any, created in the film is low; and drawing the film in a second draw step along a downweb direction under a second set of processing conditions, wherein the second set of processing conditions creates in-plane birefringence in at least one polymeric material. Exemplary roll of film includes an oriented optical film characterized by an effective orientation axis. The oriented optical film comprises only one birefringent polymeric material, at least one birefringent material and at least one isotropic material, or a first birefringent material and a second birefringent material, the birefringent materials characterized by effective orientation axes along the MD. The optical film has a width of greater than 0.3 m and a length a length greater than 10 m.

### TECHNICAL FIELD

This disclosure relates generally to optical films and methods for making optical films.

### BACKGROUND

In commercial processes, optical films made from polymeric materials or blends of materials are typically extruded from a die or cast from solvent. The extruded or cast film is then stretched to create and/or enhance birefringence in at least some of the materials. The materials and the stretching protocol may be selected to produce an optical film such as a reflective optical film, for example, a reflective polarizer or a mirror. Some such optical films may be referred to as brightness-enhancing optical films, because brightness of a liquid crystal optical display may be increased by including such an optical film therein.

### SUMMARY

In one exemplary implementation, the present disclosure is directed to methods of making optical films. One exemplary method includes providing a film comprising at least one polymeric material: widening the film under a first set of processing conditions in a first draw step along a crossweb (TD) direction such that birefringence, if any, created in the film is low; and drawing the film in a second draw step along a downweb (MD) direction under a second set of processing conditions, wherein the second set of processing conditions creates in-plane birefringence in the polymeric material and an effective orientation axis along the MD.

Another exemplary method of the present disclosure includes the steps of providing a film comprising at least a first polymeric material and a second polymeric material, drawing the film in a first draw step along a crossweb (TD) direction to widen the film under a first set of processing conditions such that low in-plane birefringence is created in the first and second polymeric materials, and drawing the film in a second draw step along a downweb (MD) direction under a second set of processing conditions to create in-plane birefringence in at least one of the first and second polymeric materials and an effective orientation axis along the MD.

Yet another exemplary method of the present disclosure includes the steps of providing a first film comprising at least a first polymeric material and a second polymeric material, drawing the first film in a first draw step along a crossweb (TD) direction to widen the first film under a first set of processing conditions such that low in-plane birefringence is created in the first and second polymeric materials, drawing the first film in a second draw step along a downweb (MD) direction under a second set of processing conditions to create in-plane birefringence in at least one of the first and second polymeric materials and an effective orientation along the MD; and attaching a second film to the first optical film.

In another exemplary implementation, the present disclosure is directed to rolls of optical film. One exemplary roll includes an oriented optical film characterized by an effective orientation axis, the oriented optical film comprising only one birefringent polymeric material. The optical film has a width of greater than 0.3 m and a length a length greater than 10 m, and the effective orientation axis is aligned along the length of the optical film (MD).

Another exemplary roll of optical film includes an oriented optical film comprising at least a first birefringent material characterized by an effective orientation axis and a second birefringent material characterized by an effective orientation axis. The oriented optical film has a width of greater than 0.3 m and a length a length greater than 10 m and the effective orientation axes are aligned along the length of the optical film (MD).

Yet another exemplary roll of optical film includes an absorbing polarizer characterized by an absorbing polarizer block axis and a reflective polarizer characterized by a reflective polarizer block axis. The reflective polarizer comprises (i) at least one birefringent material characterized by an effective orientation axis and at least one isotropic material or (ii) a first birefringent material characterized by an effective orientation axis and a second birefringent material characterized by an effective orientation axis. The optical film has a width of greater than about 0.3 m and a length greater than about 10 m, and the absorbing polarizer block axis, the effective orientation axes of the one or more birefringent materials and the reflective polarizer block axis are all aligned along the length of the optical film (MD).

The above summary is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B illustrate optical films;

FIG. 2 illustrates a blended optical film;

FIG. 3 is a schematic representation of an apparatus and process for making an optical film according to the present disclosure;

FIG. 3A is a schematic representation of an apparatus and process for making an optical film according to the present disclosure;

FIG. 4 illustrates a laminate construction in which a first optical film is attached to a second optical film;

FIGS. 5A-5B are cross-sectional views of exemplary constructions made according to the present disclosure;

FIGS. 6A-6C are cross-sectional views of exemplary constructions made according to the present disclosure;

FIG. 7 is a cross-sectional view of an exemplary construction made according to the present disclosure;

FIG. 8 is a plot of % transmission vs. wavelength for block states of exemplary films made according to the present disclosure; and

FIG. 9 is a plot of % transmission vs. wavelength for pass and block states of another exemplary film made according to the present disclosure.

### DETAILED DESCRIPTION

The present disclosure is directed to making optical films, such as optical films capable of enhancing brightness of a display. Optical films differ from other films, for example, in that they require optical uniformity and sufficient optical quality designed for a particular end use application, for example, optical displays. For the purposes of this application, sufficient quality for use in optical displays means that the films in roll form, following all processing steps and prior to lamination to other films, are free of visible defects, e.g., have substantially no color streaks or surface ridges when viewed by an unaided human eye. In addition, an optical quality film should have caliper variations over the useful film area that are sufficiently small for a particular application, e.g., no more than ±10%, ±5%, no more than ±3% and in some cases no more than ±1% of the average thickness of the film. Spatial gradient of caliper variations also should be sufficiently small to avoid undesirable appearance or properties of optical films according to the present disclosure. For example, the same amount of caliper variation will be less undesirable if it occurs over a larger area.

In one traditional commercial process used to make oriented optical films, such as reflective polarizing films, a die was constructed to make an extruded film that was then stretched along the downweb direction in a length orienter (LO), which is an arrangement of rollers rotating at differing speeds selected to stretch the film along the film length direction, which also may be referred to as the machine direction (MD). In such traditional methods, the film length increases while the film width decreases. An oriented polarizing film produced using such methods has a block axis (i.e., the axis characterized by a low transmission of light polarized along that direction) along the MD. However, it is believed that using traditional LOs to produce oriented optical films results in films of relatively narrow width, such as 0.3 m or less.

To address this problem, wide extrusion dies can be constructed to make the film of a commercially useful width. However the extruded film typically includes striations or die lines along its length. These defects typically became more severe after the film is stretched along the MD in the LO, which results in an optical film that is unacceptable for use in optical devices such as displays.

To reduce defects, such as die lines, and provide a film having a substantially uniform width, optical films, such as reflective polarizing films, have been extruded from relatively narrow dies and then stretched in a crossweb or film width direction (referred to herein as the transverse direction or TD). Usually, such reflective polarizing films have a block axis along the TD.

In some applications, it is advantageous to laminate a reflective polarizing film to a dichroic polarizing film to make, for example, a film construction for a liquid crystal display (LCD). When supplied in roll form, the dichroic polarizing film usually has a block axis along the length of the roll (MD). The block axes in the dichroic polarizing film and in the reflective polarizing film discussed above are perpendicular to one another in roll form. To make a laminate film construction for an optical display, the reflective polarizing film must first be first cut into sheets, rotated 90°, and only then laminated to the dichroic polarizing film. This laborious process makes it difficult to produce laminated film constructions in roll form on a commercial scale and increases the cost of the final product. Thus, there remains a need for wider reflective polarizing films that have a block axis in the MD.

Accordingly, the present disclosure is directed to methods for making wider oriented optical films, such as reflective polarizing films having a block or polarizing axis along their length (along the MD). The reflective polarizing films may include, without limitation, multilayer reflective polarizing films and diffusely reflective polarizing optical films. In some exemplary embodiments, the reflective polarizing films may be advantageously laminated to other optical films, such as absorbing polarizers, retarders, diffusers, protective films, surface structured films, etc., in roll-to-roll processes.

For the purposes of the present application, the term “wide” or “wide format” refers to films having a width of greater than about 0.3 m. Those of ordinary skill in the art will readily appreciate that the term “width” will be used in reference to the useful film width, since some portions of the edge of the film may be rendered unusable or defective, e.g., by the gripping members of a tenter. The wide optical films of the present disclosure have a width that may vary depending on the intended application, but widths typically range from more than 0.3 m to 10 m. In some applications, films wider than 10 m may be produced, but such films can be difficult to transport. Exemplary suitable films typically have widths from about 0.5 m to about 2 m and up to about 7 m, and currently available display film products utilize films having widths of, for example, 0.65 m, 1.3 m, 1.6 m, 1.8 m or 2.0 m. The term “roll” refers to a continuous film having a length of at least 10 m. In some exemplary embodiments of the present disclosure, the length of the film may be 20 m or more, 50 m or more, 100 m or more, 200 m or more or any other suitable length.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

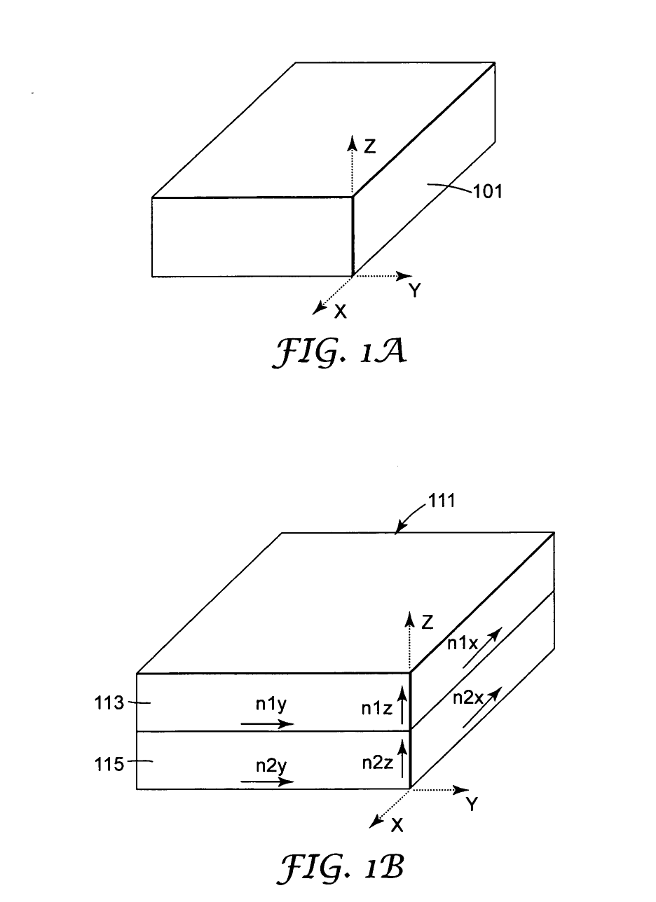

FIG. 1A illustrates a portion of an optical film construction 101 that may be used in the processes described below. The depicted optical film 101 may be described with reference to three mutually orthogonal axes x, y and z. In the illustrated embodiment, two orthogonal axes x and y are in the plane of the film 101 (in-plane, or x and y axes) and a third axis (z-axis) extends in the direction of the film thickness. In some exemplary embodiments, the optical film 101 includes at least two different materials, a first material and a second material, which are optically interfaced (e.g., two materials which combine to cause an optical effect such as reflection, scattering, transmission, etc.). In typical embodiments of the present disclosure, one or both materials are polymeric. The first and second materials may be selected to produce a desired mismatch of refractive indices in a direction along at least one axis of the film 101, for example, the MD. The materials may also be selected produce a desired match of refractive indices in a direction along at least one axis of the film 101 perpendicular to a direction along which the refractive indices are mismatched, for example, along TD.

At least one of the materials is subject to developing negative or positive birefringence under certain conditions. The materials used in the optical film are preferably selected to have sufficiently similar rheology to meet the requirements of a coextrusion process, although cast films can also be used. In other exemplary embodiments, the optical film 101 may be composed of only one material or a miscible blend of two or more materials. Such exemplary embodiments may be used as retarders or compensators in optical displays.

The optical film 101 can be a result of a film processing method that may include drawing the film. Drawing a film under different processing conditions may result in widening of the film without strain-induced orientation, widening of the film with strain-induced orientation, or strain-induced orientation of the film with lengthening. The induced molecular orientation may be used, for example, to change the refractive index of an affected material in the direction of the draw. The amount of molecular orientation induced by the draw can be controlled based on the desired properties of the film, as described more fully below.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The term “in-plane birefringence” is understood to be the difference between the maximum and minimum in-plane indices of refraction, e.g., between the in-plane refractive indices nₓ and n_{y}. The term “out-of-plane birefringence” is understood to be the difference between one of the in-plane indices (e.g., nₓ or n_{y}) of refraction and the out-of-plane index of refraction n_{z}. All birefringence and index of refraction values are reported for 632.8 nm light unless otherwise indicated.

Exemplary embodiments of the present disclosure may be characterized by “an effective orientation axis,” which is the in-plane direction in which the refractive index has changed the most as a result of strain-induced orientation. For example, the effective orientation axis typically coincides with the block axis of a polarizing film, reflective or absorbing. In general, there are two principal axes for the in-plane refractive indices, which correspond to maximum and minimum refractive index values. For a positively birefringent material, in which the refractive index tends to increase for light polarized along the main axis or direction of stretching, the effective orientation axis coincides with the axis of maximum in-plane refractive index. For a negatively birefringent material, in which the refractive index tends to decrease for light polarized along the main axis or direction of stretching, the effective orientation axis coincides with the axis of minimum in-plane refractive index.

The optical film 101 is typically formed using two or more different materials. In some exemplary embodiments, the optical film of the present disclosure includes only one birefringent material. In other exemplary embodiments, the optical film of the present disclosure includes at least one birefringent material and at least one isotropic material. In yet other exemplary embodiments, the optical film includes a first birefringent material and a second birefringent material. In such exemplary embodiments, the in-plane refractive indices of both materials change similarly in response to the same process conditions. In one embodiment, when the film is drawn, the refractive indices of the first and second materials should both increase for light polarized along the direction of the draw (e.g., the MD) while decreasing for light polarized along a direction orthogonal to the stretch direction (e.g., the TD). In another embodiment, when the film is drawn, the refractive indices of the first and second materials should both decrease for light polarized along the direction of the draw (e.g., the MD) while increasing for light polarized along a direction orthogonal to the stretch direction (e.g., the TD). In general, where one, two or more birefringent materials are used in an oriented optical film according to the present disclosure, the effective orientation axis of each birefringent material is aligned along the MD.

When the orientation resulting from a draw step or combination of draw steps causes a match of the refractive indices of the two materials in one in-plane direction and a substantial mismatch of the refractive indices in the other in-plane direction, the film is especially suited for fabricating a reflective polarizer. The matched direction forms a transmission (pass) direction for the polarizer and the mismatched direction forms a reflection (block) direction. Generally, the larger the mismatch in refractive indices in the reflection direction and the closer the match in the transmission direction, the better the performance of the polarizer.

FIG. 1B illustrates a multilayer optical film 111 that includes a first layer of a first material 113 disposed (e.g., by coextrusion) on a second layer of a second material 115. Either or both of the first and second materials may be birefringent. While only two layers are illustrated in FIG. 1B and generally described herein, the process is applicable to multilayer optical films having up to hundreds or thousands or more of layers made from any number of different materials, e.g., a plurality first layers of a first material 113 and a plurality of second layers of a second material 115. The multilayer optical film 111 or the optical film 101 may include additional layers. The additional layers may be optical, e.g., performing an additional optical function, or non-optical, e.g., selected for their mechanical or chemical properties. As discussed in U.S. Pat. No. 6,179,948, incorporated herein by reference, these additional layers may be orientable under the process conditions described herein, and may contribute to the overall optical and/or mechanical properties of the film, but for the purposes of clarity and simplicity these layers will not be further discussed in this application.

The materials in the optical film 111 are selected to have visco-elasticity characteristics to at least partially decouple the draw behavior of the two materials 113 and 115 in the film 111. For example, in some exemplary embodiments, it is advantageous to decouple the responses of the two materials 113 and 115 to stretching or drawing. By decoupling the draw behavior, changes in the refractive indices of the materials may be separately controlled to obtain various combinations of orientation states, and, consequently, the degrees of birefringence, in the two different materials. In one such process, two different materials form optical layers of a multilayer optical film, such as a coextruded multilayer optical film. The indices of refraction of the layers can have an initial isotropy (i.e., the indices are the same along each axis) although some orientation during the casting process may be purposefully or incidentally introduced in the extruded films.

One approach to forming a reflective polarizer uses a first material that becomes birefringent as a result of processing according to the present disclosure and a second material having an index of refraction which remains substantially isotropic, i.e., does not develop appreciable amounts of birefringence, during the draw process. In some exemplary embodiments, the second material is selected to have a refractive index which matches the non-drawn in-plane refractive index of the first material subsequent to the draw.

Materials suitable for use in the optical films of FIGS. 1A, 1B are discussed in, for example, U.S. Pat. No. 5,882,774, which is incorporated herein by reference. Suitable materials include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof; t-butyl isophthalic acid, trimellitic acid, sodium sulfonated isophthalic acid; 2,2′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbomanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis (2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyethylene terephthalate (PET), and copolymers thereof.

In some exemplary embodiments, a second polymer of the second optical layers should be chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,762 and 6,498,683 and U.S. patent application Ser. Nos. 09/229724, 09/232332, 09/399531, and 09/444756, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (kingsport, Tenn). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to the isotropic refractive index of the first polymer. Examples of other polymers suitable for use in optical films and, particularly, in the second optical layers, other than the CoPEN polymers discussed above, include vinyl polymers and copolymers made from monomers such as vinyl naphthalenes, styrene, maleic anhydride, acrylates, and methacrylates. Examples of such polymers include polyacrylates, polymethacrylates, such as poly(methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers and copolymers such as polyesters and polycarbonates.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008.

Yet other suitable polymers, especially for use in the second optical layers, include polyolefin copolymers such as poly(ethylene-co-octene) (PE-PO) available from Dow-Dupont Elastomers under the trade designation Engage 8200, poly(propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, PET/co-PET and PET/sPS, where “co-PET” refers to a copolymer or blend based upon terephthalic acid (as described above), ECDEL is a thermoplastic polyester commercially available from Eastman Chemical Co., and THV is a fluoropolymer commercially available from 3M Company. PMMA refers to polymethyl methacrylate and PETG refers to a copolymer of PET employing a second glycol (usually cyclohexanedimethanol). sPS refers to syndiotactic polystyrene.

In another embodiment, the optical film can be or can include a blend optical film. In some exemplary embodiments, the blend optical film may be a diffuse reflective polarizer. In a typical blend film according to the present disclosure, a blend (or mixture) of at least two different materials is used. A mismatch in refractive indices of the two or more materials along a particular axis can be used to cause incident light which is polarized along that axis to be substantially scattered, resulting in a significant amount of diffuse reflection of that light. Incident light which is polarized in the direction of an axis in which the refractive indices of the two or more materials are matched will be substantially transmitted or at least transmitted with a much lesser degree of scattering. By controlling the relative refractive indices of the materials, among other properties of the optical film, a diffusely reflective polarizer may be constructed. Such blend films may assume a number of different forms. For example, the blend optical film may include one or more co-continuous phases, one or more disperse phases within one or more continuous phases or co-continuous phases. The general formation and optical properties of various blend films are further discussed in U.S. Pat. Nos. 5,825, 543 and 6,111,696, the disclosures of which are incorporated by reference herein.

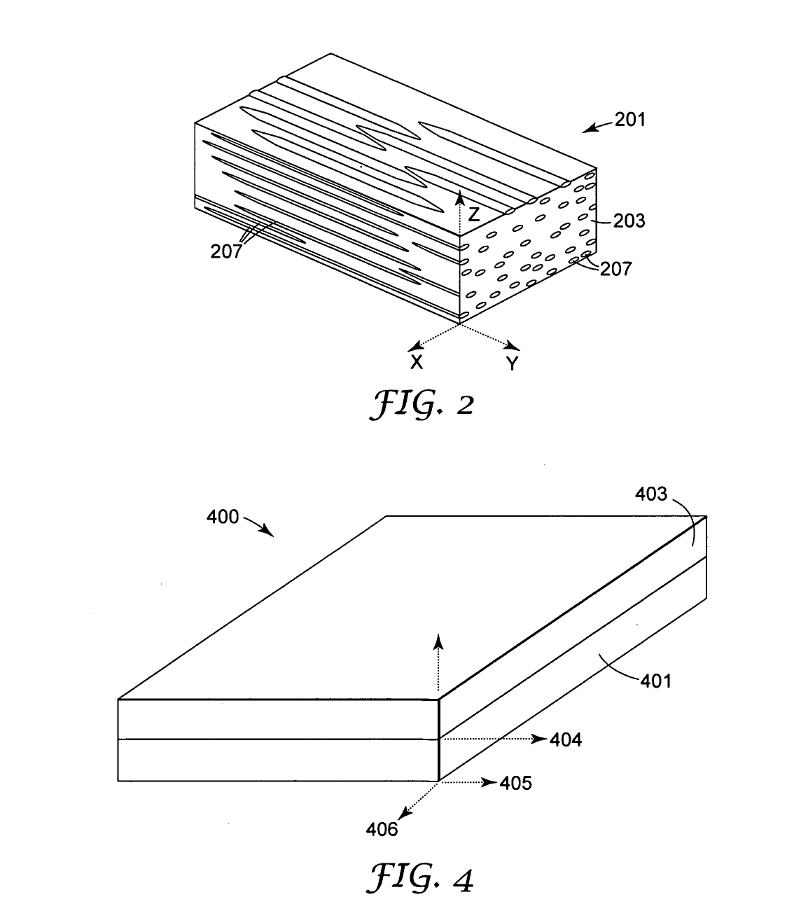

FIG. 2 illustrates an embodiment of the present disclosure formed of a blend of a first material and a second material that is substantially immiscible in the first material. In FIG. 2, an optical film 201 is formed of a continuous (matrix) phase 203 and a disperse (discontinuous) phase 207. The continuous phase may comprise the first material and the second phase may comprise the second material. The optical properties of the film may be used to form a diffusely reflective polarizing film. In such a film, the refractive indices of the continuous and disperse phase materials are substantially matched along one in-plane axis and are substantially mismatched along another in-plane axis. Generally, one or both of the materials are capable of developing in-plane birefringence as a result of stretching or drawing under the appropriate conditions. In the diffusely reflective polarizer, such as that shown in FIG. 2, it is desirable to match the refractive indices of the materials in the direction of one in-plane axis of the film as close as possible while having as large of a refractive indices mismatch as possible in the direction of the other in-plane axis.

If the optical film is a blend film including a disperse phase and a continuous phase as shown in FIG. 2 or a blend film including a first co-continuous phase and a second co-continuous phase, many different materials may be used as the continuous or disperse phases. Such materials include inorganic materials such as silica-based polymers, organic materials such as liquid crystals, and polymeric materials, including monomers, copolymers, grafted polymers, and mixtures or blends thereof. The materials selected for use as the continuous and disperse phases or as co-continuous phases in the blend optical film having the properties of a diffusely reflective polarizer may, in some exemplary embodiments, include at least one optical material that is orientable under the second set of processing conditions to introduce in-plane birefringence and at least one material that does not appreciably orient under the second set of processing conditions and does not develop an appreciable amount of birefringence.

Details regarding materials selection for blend films are set forth in U.S. Pat. Nos. 5,825,543 and 6,590,705, both incorporated by reference.

Suitable materials for the continuous phase (which also may used in the disperse phase in certain constructions or in a co-continuous phase) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters. PEN and PET, as well as copolymers of intermediate compositions, are especially preferred because of their strain induced birefringence, and because of their ability to remain permanently birefringent after stretching.

Suitable materials for the second polymer in some film constructions include materials that are isotropic or birefringent when oriented under the conditions used to generate the appropriate level of birefringence in the first polymeric material. Suitable examples include polycarbonates (PC) and copolycarbonates, polystyrene-polymethylmethacrylate copolymers (PS-PMMA), PS-PMMA-acrylate copolymers such as, for example, those available under the trade designation MS 600 (50% acrylate content) NAS 21 (20% acrylate content) from Nova Chemical, Moon Township Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC), and polychloroprene.

In one aspect, the present disclosure is directed to a method of making a roll of wide oriented optical film useful, for example, in an optical display, in which the effective orientation axis of the oriented optical film is generally aligned with the length of the roll. Rolls of this film, such as a reflective polarizing film, may be easily laminated to rolls of other optical films that have a block state axis along their length, such as absorbing polarizing films.

Exemplary methods of the present disclosure include providing an optical film that is made of at least one polymeric material, preferably at least a first and a second polymeric material, wherein at least one of the polymeric materials is capable of developing birefringence. The optical film is stretched or drawn in the crossweb (TD) direction in a first step, referred to generally herein as the first draw step, to widen the film under a first set of processing conditions such that only low in-plane birefringence, if any, is developed in the film.

The term widen as used herein refers to a process step in which the film dimensions are changed without introducing substantial molecular orientation, preferably no molecular orientation, into the polymeric molecules making up the film. When a film is widened in a first process step, the process conditions, for example, temperature, should be selected such that the film does not become unacceptably non-uniform and can meet the quality requirements for optical films following the first and second process steps.

The term orient as used herein refers to a process step in which the film dimensions are changed and molecular orientation is induced in one or more of the polymeric materials making up the film. In a second process step, referred to generally herein as the second draw step, the film is drawn in the downweb (MD) direction under a second set of processing conditions to induce sufficient birefringence in the optical film for a desired application. Further, additional stretch or draw step(s) can be employed separately or in conjunction with the first and second draw steps to improve the optical properties of the film (e.g. optical uniformity, warp, peel adhesion, birefringence and the like).

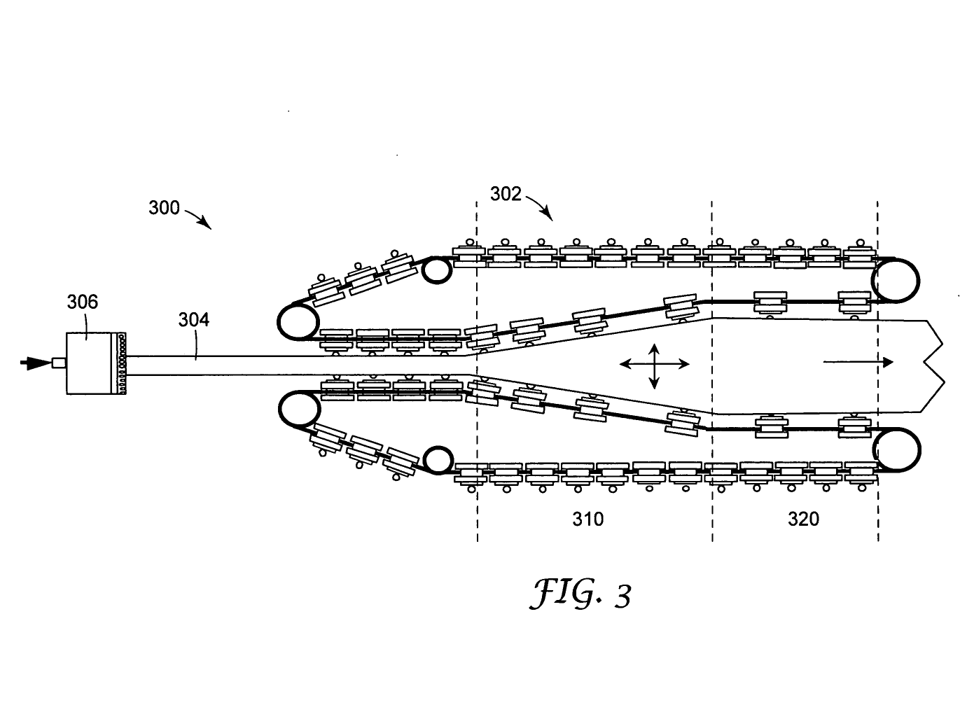

An exemplary process for making the oriented optical films according to the present disclosure is schematically outlined in FIG. 3. First, an optical film is provided to an apparatus 300 that allows the film to be stretched in the crossweb (TD) or downweb (MD) direction, or both, as desired. The stretching steps applied to the film may be sequential or simultaneous. For example, the apparatus in FIG. 3 may include an arrangement of chain or magnetically driven clips 302 that grip the edges of the film web. The individual clips may be computer controlled to provide a wide variety of stretching profiles for the film web 304 as it moves through the apparatus 300.

In an alternative embodiment not shown in FIG. 3, the optical film 304 may be stretched in a profile dictated by an arrangement of varying-pitched screws. The screws control the profile and relative amount of MD stretch and lie along rails that control the TD profile and stretch in combination with other process conditions. In yet another embodiment not shown in FIG. 3, the optical film 304 may be stretched in a profile dictated by a mechanical pantograph-rail system, where the individual clip separation, which in part controls the MD stretch ratio, is controlled by a mechanical pantograph where the TD stretch ratio is in part dictated by the rail path the clips travel. Some exemplary methods and apparatuses suitable for stretching the films according to the present disclosure are described in Kampf U.S. Pat. No. 3,150,433 and Hommes U.S. Pat. No. 4,853,602, both incorporated by reference herein. The film 304 provided into the apparatus 300 may be a solvent cast or an extrusion cast film. In the embodiment illustrated in FIG. 3, the film 304 is an extruded film expelled from a die 306 and including at least one, and preferably two polymeric materials. The optical film 304 may vary widely depending on the intended application, and may have a monolithic structure as shown in FIG. 1A, a layered structure as shown in FIG. 1B, or a blend structure as shown in FIG. 2, or a combination thereof.

The material selected for use in the optical film 304 should preferably be free from any undesirable orientation prior to the subsequent draw processes. Alternatively, deliberate orientation can be induced during the casting or extrusion step as a process aid to the first draw step. For example, the casting or extrusion step may be considered part of the first draw step. The materials in the film 304 are selected based on the end use application of the optical film, which, following all draw steps, will develop in-plane birefringence and may have reflective properties such as reflective polarizing properties. In one exemplary embodiment described in detail in this application, the optically interfaced materials in the film 304 are selected to provide a film, following all orientation steps, with the properties of a reflective polarizer.

Referring further to FIG. 3, once the optical film 304 is extruded from the die 306 or otherwise provided, the optical film 304 is stretched in a first draw step in the zone 310 by an appropriate arrangement of the clips 302 gripping the edges of the film 304. The first draw step is performed under a first set of processing conditions (at least one of draw temperature, draw rate, and draw ratio (e.g. ratio of TD/MD draw rates)) such that the film 304 becomes wider in the crossweb (TD) direction. The first set of processing conditions should be selected such that any additional birefringence induced in the film is low: no more than slight birefringence, preferably substantially no birefringence, and most preferably no birefringence, should be induced in the polymeric materials in the film 304 in the first draw step. In some exemplary embodiments, following the first draw step, the in-plane birefringence is less than about 0.05, less than about 0.03, more preferably less than about 0.02, and most preferably less than about 0.01.

The tendency of a polymeric material to orient under a given set of processing conditions is a result of the visco-elastic behavior of polymers, which is generally the result of the rate of molecular relaxation in the polymeric material. The rate of molecular relaxation can be characterized by an average longest overall relaxation time (i.e., overall molecular rearrangement) or a distribution of such times. The average longest relaxation time typically increases with decreasing temperature and approaches a very large value near the glass transition temperature. The average longest relaxation time can also be increased by crystallization and/or crosslinking in the polymeric material which, for practical purposes, inhibits any relaxation of this longest mode under process times and temperatures typically used. Molecular weight and distribution as well as chemical composition and structure (e.g., branching) can also effect the longest relaxation time.

When the average longest relaxation time of a particular polymeric material is about equal to or longer than the process draw time, substantial molecular orientation will occur in the material in the direction of the draw. Thus, high and low strain rates correspond to processes which draw the material over a period of time which is less than or greater than the average longest relaxation time, respectively. The response of a given material can be altered by controlling the draw temperature, draw rate and draw ratio of the process.

The extent of orientation during a draw process can be precisely controlled over a broad range. In certain draw processes, it is possible that the draw process actually reduces the amount of molecular orientation in at least one direction of the film. In the direction of the draw, the molecular orientation induced by the draw process ranges from substantially no orientation, to slight optical orientation (e.g., an orientation which produces negligible effects on the optical performance of the film), to varying degrees of optical orientation that can be removed during subsequent process steps.

The relative strength of optical orientation depends on the material and the relative refractive indices of the film. For example, strong optical orientation may be in relation to the total intrinsic (normalized) birefringence of the given materials. Alternatively, the draw strength may be in relation to the total amount of achievable normalized index difference between the materials for a given draw process sequence. It should also be appreciated that a specified amount of molecular orientation in one context may be considered strong optical orientation and in another context it may be considered weak or non-optical orientation. For example, a certain amount of birefringence between a first in-plane axis and an out-of-plane axis may be considered low when viewed in the context of a very large birefringence between a second in-plane axis and an out-of-plane axis. Processes which occur in a short enough time and/or at a low enough temperature to induce some or substantial optical molecular orientation of at least one material included in the optical film of the present disclosure are weak or strong optically orienting draw processes, respectively. Processes that occur over a long enough period and/or at high enough temperatures such that little or no molecular orientation occurs are weak or substantially non-optically orienting processes, respectively.

By selecting the materials and process conditions in consideration of the orienting/non-orienting response of the one or more materials to the process conditions, the amount of orientation, if any, along the axis of each draw step may be separately controlled for each material. However, the amount of molecular orientation induced by a particular draw process does not by itself necessarily dictate the resulting film's molecular orientation. A non-optically effective amount of orientation in the first draw process may be permitted for one material in order to compensate for or assist with further molecular orientation in a second or subsequent draw process.

Although the draw processes define the orientational changes in the materials to a first approximation, secondary processes such as densification or phase transitions such as crystallization can also influence the orientational characteristics. In the case of extreme material interaction (e.g. self-assembly, or liquid crystalline transitions), these effects may be over-riding. In typical cases, for example, a drawn polymer in which the main chain backbone of the polymer molecule tends to align with the flow, effects such as strain-induced crystallization tend to have only a secondary effect on the character of the orientation. Strain-induced and other crystallization, does, however, have a significant effect on the strength of such orientation (e.g., may turn a weakly orienting draw into a strongly orienting draw). Therefore, neither of the materials selected for the use in the optical film 304 should be capable of rapid crystallization, and one of the materials should not be capable of appreciable crystallization, under the first set of processing conditions applied in the first draw step. As a result, in some applications, a coPEN that crystallizes more slowly than PEN under the first set of processing conditions, such as a copolymer of PEN and PET, may be preferred. A suitable example is a copolymer of 90% PEN and 10% PET, referred to herein as low melting point PEN (LmPEN).

The first set of processing conditions in the first draw step may vary widely depending on the polymer or polymers making up the film 304. In general, at high temperatures, low draw ratios and/or low strain rates, polymers tend to flow when drawn like a viscous liquid with little or no molecular orientation. At low temperatures and/or high strain rates, polymers tend to draw elastically like solids with concomitant molecular orientation. A low temperature process is typically below, preferably near, the glass transition temperature of amorphous polymeric materials while a high temperature process is usually above, preferably substantially above, the glass transition temperature. Therefore, the first draw step typically should be performed at high temperatures (above the glass transition temperature) and/or low strain rates to provide little or no molecular orientation. In typical embodiments of the present disclosure, in the first draw step, the temperature should be high enough that the polymers do not appreciably orient, but not so high as to cause one or more polymers of the optical film to quiescently crystallize. Quiescent crystallization is sometimes considered undesirable, because it may cause deleterious optical properties, such as excessive haze. In addition, the time over which the film is heated, i.e., the temperature ramp-up rate, should be adjusted to avoid undesirable orientation.

For example, in an optical film such as shown in FIG. 1B, with PEN as a high refractive index material, the temperature range for the first draw step is about 20° C. to about 100° C. above the glass transition temperature of at least one of the polymers of the optical film and sometimes all of the polymers of the optical film. In some exemplary embodiments, the temperature range for the first draw step is about 20° C. to about 40° C. above the glass transition temperature of at least one of the polymers of the optical film and sometimes all of the polymers of the optical film.

In the first draw step where the first processing conditions are applied, for example in zone 310 shown in FIG. 3, the film 304 is preferably stretched or drawn in the crossweb (TD) direction. However, the film 304 may optionally also be stretched or drawn in the downweb (MD) direction at the same time the stretch/draw in the crossweb (TD) direction occurs, i.e. the film may be biaxially stretched or drawn, or the film 304 may be stretched in the MD direction subsequent to the stretch in the TD, so long as only low in-plane birefringence, e.g., slight in-plane birefringence, preferably substantially no in-plane birefringence, and more preferably no in-plane birefringence is introduced in the polymeric materials of the film 304.

Following the application to the film 304 of the first set of processing conditions, in another, often subsequent, second draw step a second set of processing conditions is applied to the film in zone 320 shown in FIG. 3. In the second draw step, the optical film 304 is drawn in the downweb (MD) direction such that birefringence is induced in at least one polymeric material in the film and such that after the second draw step, the effective orientation axis of the at least one birefringent material is disposed along the MD. In the embodiment where the optical film includes a first and a second polymeric material, refractive index mismatch is preferably induced between a first material and a second material along a first in-plane axis (e.g., MD) and substantially no refractive index mismatch is induced between the first and the second materials along a second in-plane axis that is orthogonal to the first in-plane axis (e.g., TD). In some exemplary embodiments, the first in-plane axis coincides with the effective orientation axis.

In some exemplary embodiments, in-plane birefringence introduced in the second draw step is at least about 0.06, at least about 0.07, preferably at least about 0.09, more preferably at least about 0.11, and even more preferably at least about 0.2. In the exemplary embodiments that include at least a first and a second different polymeric materials, following the second draw step the in-plane indices of refraction of the first and second materials along the MD may differ by at least about 0.05, preferably at least about 0.1, more preferably at least about 0.15, and most preferably at least about 0.2. More generally, in case of a reflective polarizer, it is desirable to have the value of refractive index mismatch along the MD as large as possible without significantly degrading other aspects of the optical film. These properties can be improved by additional steps/processes occurring simultaneously with or after the second draw step, described below.

Furthermore, in the exemplary embodiments that include at least a first and a second different polymeric materials, following the second draw step the in-plane indices of refraction of the first and second materials along the TD may differ by less than about 0.03, more preferably, less than about 0.02, and most preferably, less than about 0.01. In other exemplary embodiments these conditions may be met following the first and second draw steps or following any additional process steps.

While the exact details of the second set of processing conditions may vary widely depending on the materials selected for use in the optical film 304, the second set of processing conditions typically includes a lower temperature than the first set of processing conditions, and may also include a higher draw rate and/or draw ratio. For example, in a layered optical film such as shown in FIG. 1A, with PEN as a high index material and coPEN as a low index material, the temperature range used in the second draw step should be about 10° C. below the glass transition temperature to about 60° C. above the glass transition temperature of the polymeric materials in the optical film. To produce a reflective polarizer, for example, following the second draw step it is generally desirable that the difference if any, in the matched refractive indices, e.g., in the in-plane (TD) direction, be less than about 0.05, more preferably less than about 0.02, and most preferably less than about 0.01. In the mismatched direction e.g., in-plane (MD) direction, it is generally desirable that the difference in refractive indices be at least about 0.06, more preferably greater than about 0.09, and even more preferably greater than about 0.11. More generally, it is desirable to have this difference as large as possible without significantly degrading other aspects of the optical film.

In some exemplary embodiments, following the completion of the second draw step in the apparatus 300, the film 304 may be processed through additional draw steps as desired for a particular application. The second or additional draw steps may be performed on a LO along the same process line, or the film may be removed from the process line 300 and moved to a different process line and introduced into the LO using a roll-to-roll process. If desired, the birefringence of the film may be altered in the second or additional steps. Following the second and/or additional draw steps, the film or any layer or film disposed thereon may optionally be treated by applying any or all of corona treatments, primer coatings or drying steps in any order to enhance its surface properties, e.g., for subsequent lamination steps.

In another embodiment of an exemplary apparatus 440 according to the present disclosure, shown in FIG. 3A, the optical film 452 is extruded from a die 450, or otherwise provided to the remainder of the apparatus, and stretched or drawn in a first draw step along the TD in a zone 442 of a tenter 454. In the embodiment shown in FIG. 3A, the first draw step is performed under a first set of processing conditions (at least one of draw temperature, draw rate, and draw ratio (e.g. ratio of TD/MD draw rates)) such that only low in-plane birefringence, no more than slight in-plane birefringence, preferably substantially no in-plane birefringence, and most preferably no in-plane birefringence, is induced in the polymeric materials in the film. Next, the film is length oriented along the MD in a second draw step by an arrangement of low speed rollers 456 and high speed rollers 458. The second draw step is performed under a second set of processing conditions (at least one of draw temperature, draw rate, and draw ratio (e.g. ratio of TD/MD draw rates)) such that in-plane birefringence is induced in at least one polymeric material in the film to form an effective orientation axis along the MD direction. Prior to or after the second draw step, the film or any layer or film disposed thereon may optionally be treated by applying any or all of corona treatments, primer coatings or drying steps in any order to enhance its surface properties for subsequent lamination steps.

While a particular order is exemplified for the various draw processes described in the above embodiments, the order is used to facilitate an explanation and is not intended to be limiting. In certain instances the order of the processes can be changed or performed concurrently as long as subsequently performed processes do not adversely affect previously performed processes. For example, as noted above, the optical film may be drawn in both directions at the same time. When the film is concurrently drawn along both in-plane axes the draw temperature will be the same for the materials in the film. The draw ratio and rate, however, may be separately controlled. For example, the film may be drawn relatively quickly in the MD and relatively slowly in the TD.

The materials, draw ratio and rate of the concurrent biaxial draw may be suitably selected such that a draw along a first draw axis (e.g., the quick draw) is optically orienting for one or both materials along the first draw axis while the draw in the other direction (e.g., the slow draw) is non-orienting (or non-optically orienting for one of the two materials along the second draw axis. Thus, the response of the two materials to the draw in each direction may be independently controlled.

Following the second or third, or any number of suitable additional draw steps used to achieve the aforementioned MD orientation of the effective orientation axis of one or more birefringent materials comprised in the oriented optical film, the oriented optical film may be laminated to or otherwise combined with a wide variety of materials to make various optical constructions, some of which may be useful in display devices, such as LCDs. Oriented optical films of the present disclosure or any suitable laminate constructions including oriented optical films according to the present disclosure can be advantageously provided in roll form.

For example, any of the polarizing films described above may be laminated with or have otherwise disposed thereon a structured surface film such as those available under the trade designation BEF from 3M Company of St. Paul, Minn. In one embodiment, the structured surface film includes an arrangement of substantially parallel linear prismatic structures or grooves. In some exemplary embodiments, the optical film 304 may be laminated to a structured surface film including an arrangement of substantially parallel linear prismatic structures or grooves. The grooves may be aligned along the down web (MD) direction (and along the effective orientation axis or the block axis in case of a reflective polarizer), or the grooves may be aligned along the crossweb (TD) direction (and along the transmission or pass axis of a reflective polarizer film). In other exemplary embodiments, the grooves of an exemplary structured surface film may be oriented at another angle with respect to the effective orientation axis of the oriented optical film according to the present disclosure.

Those of ordinary skill in the art will readily appreciate that the structured surface may include any other types of structures, a rough surface or a matte surface. Such exemplary embodiments may also be produced by inclusion of additional steps of coating a curable material onto the optical film of the present disclosure, imparting surface structures into the layer of curable material and curing the layer of the curable material.

Since exemplary reflective polarizers made according to the processes described herein have a block axis along the downweb (MD) direction, the reflective polarizers may simply be roll-to-roll laminated to any length oriented polarizing film. In other exemplary embodiments, the film may be coextruded with a layer of absorbing polarizer material, such as a dichroic dye material or PVA-containing layer, or coated with such a layer prior to the second draw step.

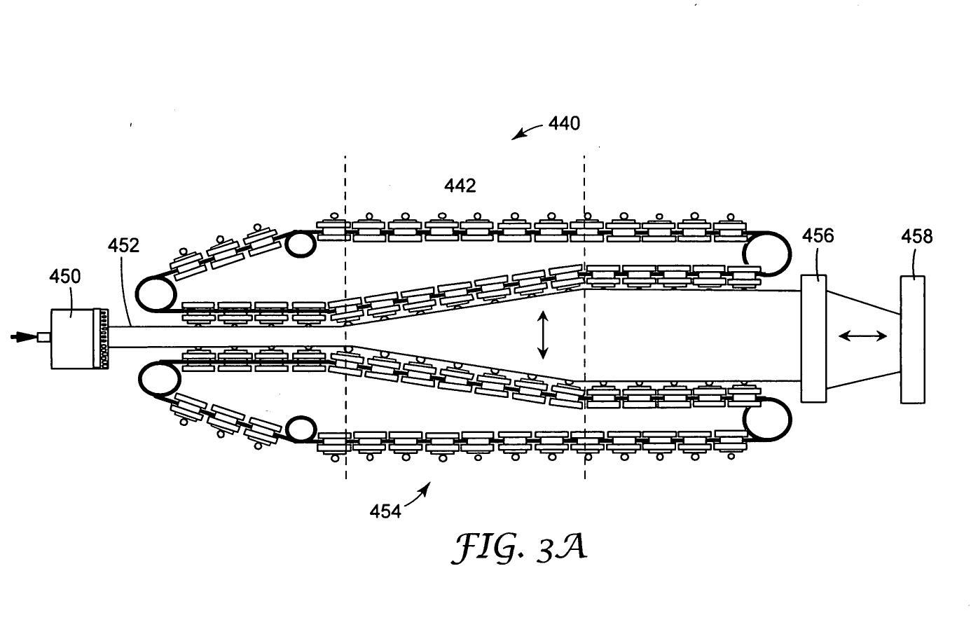

FIG. 4 illustrates an optical film construction 400 in which a first optical film 401, such as a reflective polarizer with a block axis along a direction 405, is combined with a second optical film 403. The second optical film 403 may be another type of optical or non-optical film such as, for example, an absorbing polarizer, with a block axis along a direction 404.

In the construction shown in FIG. 4, the block axis 405 of the reflective polarizing film 401 should be aligned as accurately as possible with the block axis 404 of the dichroic polarizing film 403 to provide acceptable performance for a particular application as, for example, a brightness enhancement polarizer. The pass or transmission axis of the reflective polarizing film is designated as 406. Increased mis-alignment of the axes 404, 405 diminishes the gain produced by the laminated construction 400, and makes the laminated construction 400 less useful for some display applications. For example, for a brightness enhancement polarizer the angle between the block axes 404, 405 in the construction 400 should be less than about ±10°, more preferably less than about ±5° and more preferably less than about ±3°.

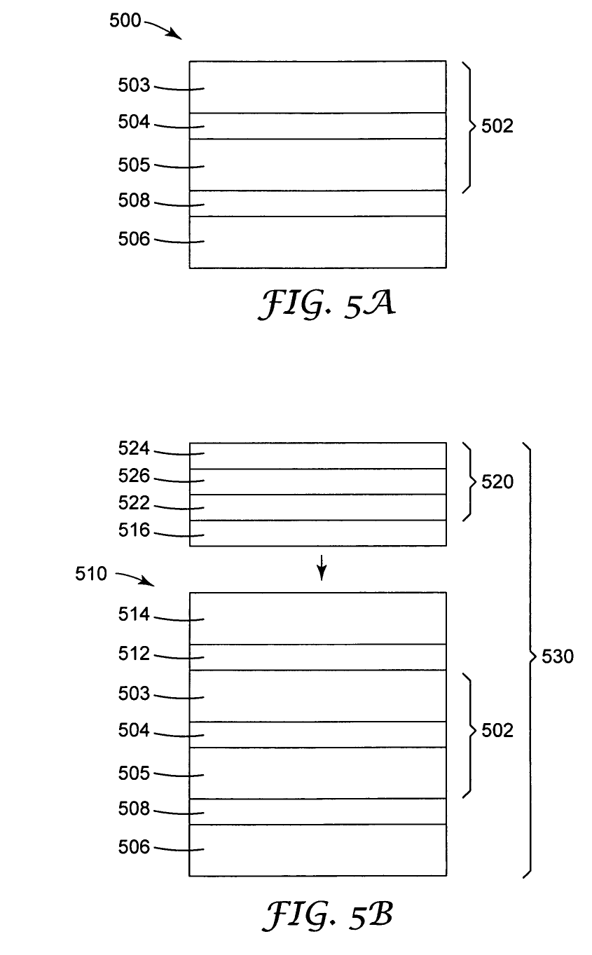

In an embodiment shown in FIG. 5A, a laminate construction 500 includes an absorbing polarizing film 502. In this exemplary embodiment, the absorbing polarizing film includes a first protective layer 503. The protective layer 503 may vary widely depending on the intended application, but typically includes a solvent cast cellulose triacetate (TAC) film. The exemplary construction 500 further includes a second protective layer 505, as well as an absorbing polarizer layer 504, such as an iodine-stained polyvinyl alcohol (I₂PVA). In other exemplary embodiments, the polarizing film may include only one or no protective layers. The absorbing polarizing film 502 is laminated or otherwise bonded to or disposed on an optical film reflective polarizer 506 (as described herein having an MD block axis), for example, with an adhesive layer 508.

Any suitable absorbing polarizing materials may be used in the absorbing polarizing films of the present disclosure. For example, in addition to iodine-stained polyvinyl alcohol (I₂/PVA)-based polarizers, the present disclosure encompasses polyvinylidene-based light polarizers (referred to as KE-type polarizers, and further described in U.S. Pat. No. 5,973,834, incorporated by reference herein), iodine-based polarizers, dyed PVOH polarizers and other suitable absorbing polarizers.

FIG. 5B shows an exemplary polarizer compensation structure 510 for an optical display, in which the laminate construction 500 is bonded to an optional birefringent film 514 such as, for example, a compensation film or a retarder film, with an adhesive 512, typically a pressure sensitive adhesive (PSA). In the compensation structure 510, either of the protective layers 503, 505 may optionally be replaced with a birefringent film, such as a compensator or a retarder, that is the same or different than the compensation film 514. Such optical films may be used in an optical display 530. In such configurations, the compensation film 514 may be adhered via an adhesive layer 516 to an LCD panel 520 including a first glass layer 522, a second glass layer 524 and a liquid crystal layer 526.

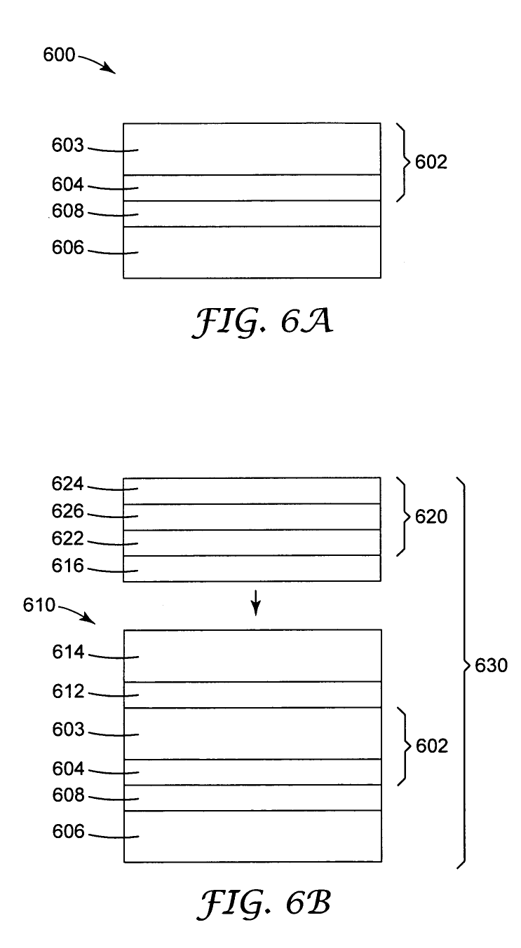

Referring to FIG. 6A, another exemplary laminate construction 600 is shown that includes an absorbing polarizing film 602 having a single protective layer 603 and an absorbing polarizing layer 604, e.g., a I₂/PVA layer. The absorbing polarizing film 602 is bonded to an MD polarization axis optical film reflective polarizer 606, for example, with an adhesive layer 608. In this exemplary embodiment, the block axis of the absorbing polarizer is also along the MD. Elimination of either or both of the protective layers adjacent to the absorbing polarizer layer 604 can provide a number of advantages including, for example, reduced thickness, reduced material costs, and reduced environmental impact (solvent cast TAC layers not required).

FIG. 6B shows a polarizer compensation structure 610 for an optical display, in which the laminate construction 600 is bonded to an optional birefringent film 614 such as, for example, a compensation film or a retarder film, with an adhesive 612. In the compensation structure 610, the protective layer 603 may optionally be replaced with a birefringent film that is the same or different than the compensation film 614. Such optical films may be used in an optical display 630. In such configurations, the birefringent film 614 may be adhered via an adhesive layer 616 to an LCD panel 620 including a first glass layer 622, a second glass layer 624 and a liquid crystal layer 626.

FIG. 6C shows another exemplary polarizer compensation structure 650 for an optical display. The compensation structure 650 includes an absorbing polarizing film 652 with a single protective layer 653 and an absorbing polarizer layer 654, such as I₂/PVA layer. The absorbing polarizing film 652 is bonded to an MD block axis reflective polarizer 656, for example, with an adhesive layer 658. In the compensation structure 650, the protective layer 653 may optionally be replaced with a compensation or retarder film. To form an optical display 682, the absorbing polarizer layer 654 may be adhered via adhesive layer 666 to an LCD panel 670 including a first glass layer 672, a second glass layer 674 and a liquid crystal layer 676.

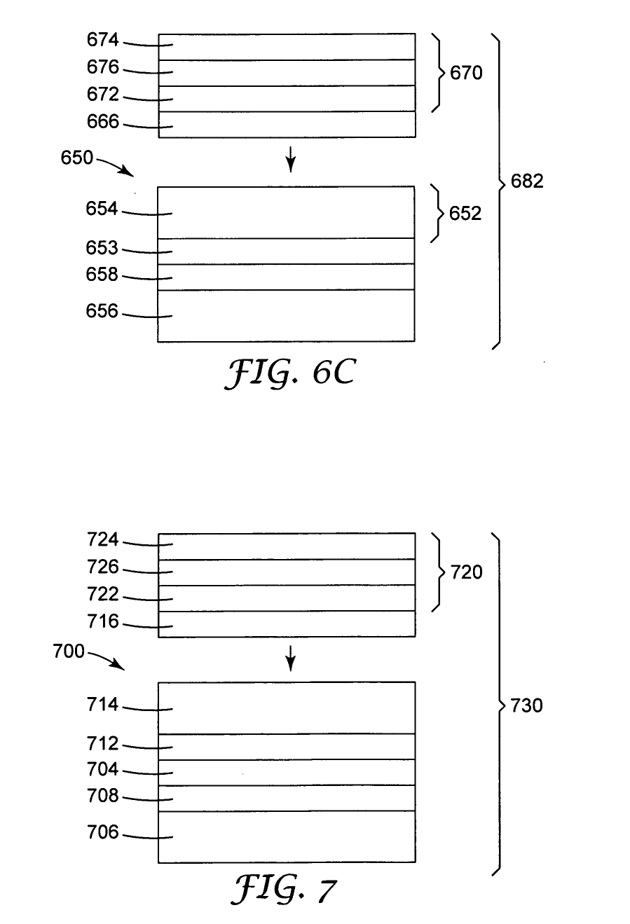

FIG. 7 shows another exemplary polarizer compensation structure 700 for an optical display, in which the absorbing polarizing film includes a single layer of absorbing polarizer material (e.g., I₂/PVA) layer 704 without any adjacent protective layers. One major surface of the layer 704 is bonded to an MD block axis optical film reflective polarizer 706 such that the block axis of the absorbing polarizer is also along MD. Bonding may be accomplished with an adhesive layer 708. The opposite surface of the layer 704 is bonded to an optional birefringent film 714 such as, for example, a compensation film or a retarder film, with an adhesive 712. Such optical films may be used in an optical display 730. In such exemplary embodiments, the birefringent film 714 may be adhered via adhesive layer 716 to an LCD panel 720 including a first glass layer 722, a second glass layer 724 and a liquid crystal layer 726.

The adhesive layers in FIGS. 5-7 above may vary widely depending on the intended application, but pressure sensitive adhesives and H₂O solutions doped with PVA are expected to be suitable to adhere the I₂/PVA layer directly to the reflective polarizer. Optional surface treatment of either or both of the reflective polarizer film and the absorbing polarizer film using conventional techniques such as, for example, air corona, nitrogen corona, other corona, flame, or a coated primer layer, may also be used alone or in combination with an adhesive to provide or enhance the bond strength between the layers. Such surface treatments may be provided in-line with the first, second draw steps or considered separate steps and may be prior to the first draw step, prior to the second draw step, subsequent to the first and second draw steps or subsequent to any additional draw steps. In other exemplary embodiments, a layer of absorbing polarizer material may be coextruded with an exemplary optical film of the present disclosure.

The following examples include exemplary materials and processing conditions in accordance with different embodiments of the disclosure. The examples are not intended to limit the disclosure but rather are provided to facilitate an understanding of the invention as well as to provide examples of materials particularly suited for use in accordance with the various above-described embodiments. Those of ordinary skill in the art will readily appreciate that exemplary embodiments shown in FIGS. 5-7 may be modified in any way consistent with the spirit of the present disclosure. For example, any suitable number or combination of layers or films described above may be used in exemplary embodiments of the present disclosure.

### EXAMPLES

In the following examples, the samples were heated for stretching for 10 to 60 seconds, as appropriate for the specific materials. Most typical heating times were 30 to 50 seconds. In the first draw step, the films were stretched by 10 to 60% per second, and more typically by 20 to 50% per second. In the second draw step, the films were stretched by 40 to 150% per second, and more typically by 60 to 100% per second. The terms “initial” and “final” are used to refer to the first and second draw steps, respectively.

### Example 1

Monolayer PEN cast film was stretched according to the processing conditions set forth in Table 1 below.

TABLE 1

| | | | | | Stretch | Stretch | | | | | |
|---|---|---|---|---|---|---|---|---|---|---|---|
| | | | | | Temp | Temp | | | | | |
| | TD | TD | MD | MD | Initial | Final | | | | | |
| Sample | Initial | Final | Initial | Final | ° C. | ° C. | n_{md} | n_{td} | n_{zd} | Δn_{MD} − n_{TD} | Δn_{TD} − n_{ZD} |
| C | 2 | 2 | 3 | 5 | 148 | 148 | 1.806 | 1.641 | 1.522 | 0.165 | 0.119 |

It is believed that process C could be used to generate a reflective polarizer if used as an optical layer in a multilayer optical film or a component of a diffusely reflective polarizing film.

### Example 2

Monolayer cast films of a copolymer having a 95:5 ratio by weight of PEN:PET (COPEN) were stretched according to the processing conditions set forth in Table 2 below.

TABLE 2

| | | | | | Stretch | Stretch | | | | | |
|---|---|---|---|---|---|---|---|---|---|---|---|
| | | | | | Temp | Temp | | | | | |
| | TD | TD | MD | MD | Initial | Final | | | | | |
| Sample | Initial | Final | Initial | Final | ° C. | ° C. | n_{md} | n_{td} | n_{zd} | Δn_{MD} − n_{TD} | Δn_{TD} − n_{ZD} |
| F | 2 | 2 | 3 | 7.3 | 153 | 135 | 1.784 | 1.645 | 1.541 | 0.139 | 0.104 |
| I | 2 | 2 | 3 | 7.3 | 150 | 135 | 1.763 | 1.625 | 1.555 | 0.137 | 0.070 |
| J | 2 | 2 | 3 | 7.3 | 150 | 140 | 1.749 | 1.625 | 1.570 | 0.124 | 0.055 |

It is believed that any of these processes could be used to generate a reflective polarizer if the above-referenced layer is used as an optical layer in a multilayer optical film or as a component of a diffusely reflective polarizing. Sample F has a relatively small difference between Δn_{MD}-n_{TD} and Δn_{TD}-n_{ZD}. Samples I and J have lower Δn_{TD}-n_{ZD} and thus would have lower off angle color if they were in a reflective polarizer, compared to the other samples.

### Example 3

Monolayer cast films of a copolymer having a 90:10 ratio by weight of PEN:PET (COPEN or LmPEN) were stretched according to the processing conditions set forth in Table 3 below.

TABLE 3

| | | | | | Stretch | Stretch | | | | | |
|---|---|---|---|---|---|---|---|---|---|---|---|
| | | | | | Temp | Temp | | | | | |
| | TD | TD | MD | MD | Initial | Final | | | | | |
| Sample | Initial | Final | Initial | Final | ° C. | ° C. | n_{md} | n_{td} | n_{zd} | Δn_{MD} − n_{TD} | Δn_{TD} − n_{ZD} |
| M | 2 | 2 | 3 | 7.3 | 150 | 135 | 1.728 | 1.631 | 1.561 | 0.096 | 0.071 |
| S | 2 | 2 | 2 | 7.3 | 147 | 130 | 1.753 | 1.633 | 1.557 | 0.119 | 0.077 |

It is believed that any of these processes could be used to generate a reflective polarizer if used as a polymeric film layer in an optical film. Sample M had a relatively low difference between Δn_{MD}-n_{TD} and Δn_{TD}-n_{ZD}.

### Example 4

Monolayer cast film of a copolymer having a 60:40 ratio by weight of PEN:PET (COPEN) was stretched according to the processing conditions set forth in Table 4 below.

TABLE 4

| | | | | | Stretch | Stretch | | | | | |
|---|---|---|---|---|---|---|---|---|---|---|---|
| | | | | | Temp | Temp | | | | | |
| | TD | TD | MD | MD | Initial | Final | | | | | |
| Sample | Initial | Final | Initial | Final | ° C. | ° C. | n_{md} | n_{td} | n_{zd} | Δn_{MD} − n_{TD} | Δn_{TD} − n_{ZD} |
| W | 2 | 2 | 3 | 7.3 | 115 | 110 | 1.735 | 1.609 | 1.537 | 0.126 | 0.072 |

It is believed that sample W could be used to generate a reflective polarizer if used as a polymeric film layer in an optical film.

### Example 5

Multilayer LmPEN HIO/CoPEN 55:45 HD LIO films were stretched according to the processing conditions set forth in Table 5 below.

TABLE 5

| | | | | | | Stretch | |
|---|---|---|---|---|---|---|---|
| | | | | | | Temp | Stretch |
| | MOF cast | TD | TD | MD | MD | initial | Temp |
| Sample | film | initial | final | initial | final | (step 1) | (step 2) |
| RP-X | LmPEN HIO/ | 3 | 3 | 3 | 6.5 | 150 | 135 |
| | CoPEN 55:45 | | | | | | |
| | HD LIO | | | | | | |
| RP-Y | LmPEN HIO/ | 2 | 2 | 2 | 6.5 | 150 | 135 |
| | CoPEN 55:45 | | | | | | |
| | HD LIO | | | | | | |
| RP-Z | LmPEN HIO/ | 2 | 2 | 1 | 6.5 | 150 | 135 |
| | CoPEN 55:45 | | | | | | |
| | HD LIO | | | | | | |

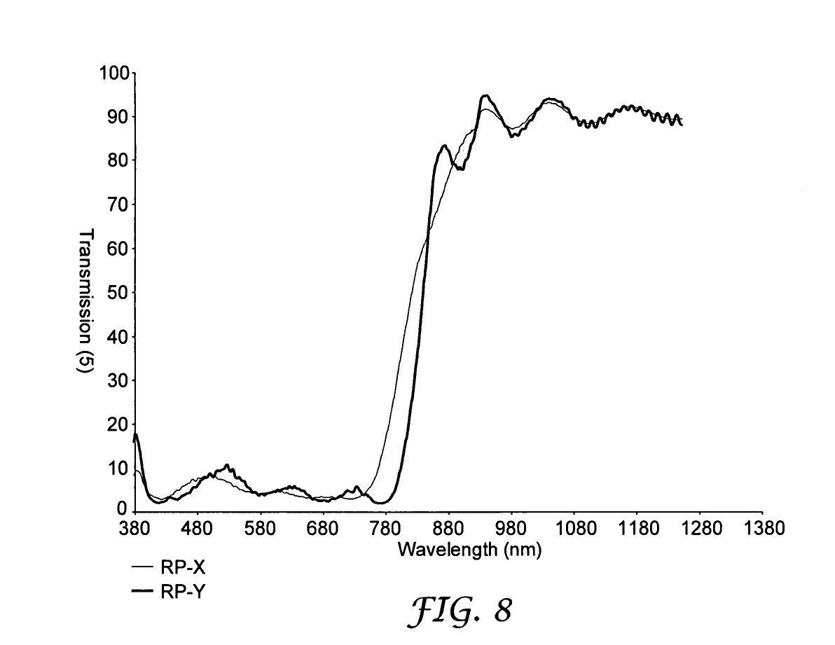

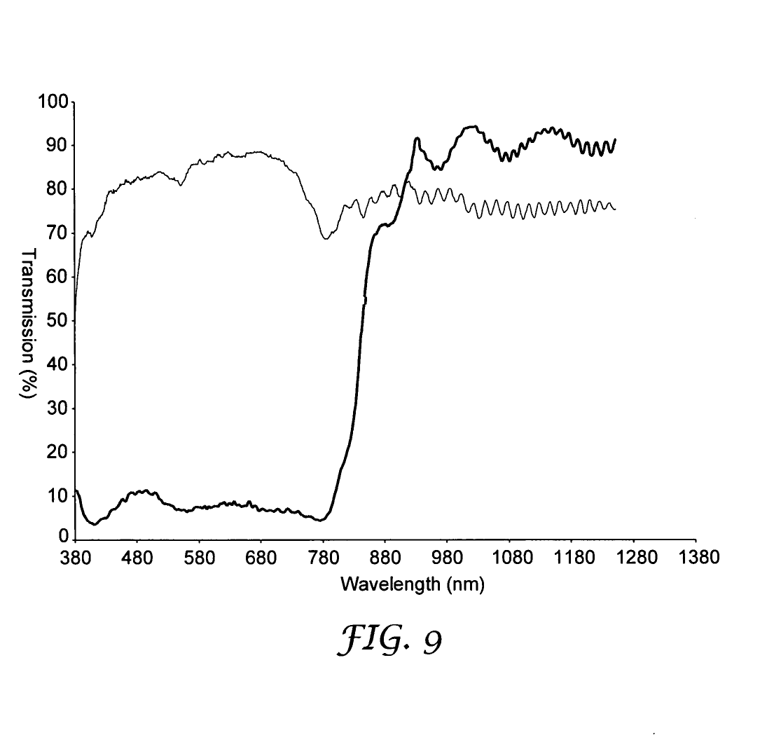

Samples RP-X and -Y were simultaneously biaxially stretched in the first draw step while the first draw step of sample RP-Z was a constrained uniaxial stretch, i.e., stretched in the TD in a standard tenter. For example, Samples RP-X and Y represent a type of process that could be performed as illustrated by FIG. 3, while RP-Z was stretched in a manner similar to FIG. 3A. FIG. 8 shows block state spectra for samples RP-X and PR-Y. FIG. 9 shows pass (transmission) and block state spectra for the sample RP-Z. Thus, it is believed that all three samples could be used as reflective polarizers.

What is claimed is:

1. A method of making an optical film, comprising:
providing a film comprising at least one polymeric material;
widening the film under a first set of processing conditions in a first draw step along a crossweb (TD) direction such that birefringence, if any, created in the film is low, and
drawing the film in a second draw step along a downweb (MD) direction under a second set of processing conditions, wherein the second set of processing conditions creates in-plane birefringence in the polymeric material and an effective orientation axis along the MD.

2. The method of claim 1, wherein the temperature of the film under the first processing conditions is greater than the temperature of the film under the second processing conditions.

3. The method of claim 1, wherein the temperature of the film in the first draw step is from 20-100° C. above the glass transition temperature of the polymer, and wherein the temperature of the film in the second draw step is from 10° C. below the glass transition temperature of the polymer to 40° C. above the glass transition temperature of the polymer.

4. The method of claim 1, wherein the film is more than 0.3 m wide following the second draw step.

5. The method of claim 1, wherein birefringence of the created in the first draw step is less than 0.05 and birefringence created in the second drawing step is at least 0.06.

6. A method of making an optical film, comprising:
providing a film comprising at least a first polymeric material and a second polymeric material,
drawing the film in a first draw step along a crossweb (TD) direction to widen the film under a first set of processing conditions such that low birefringence is created in the first and second polymeric materials along the TD direction, and
drawing the film in a second draw step along a downweb (MD) direction under a second set of processing conditions to create in-plane birefringence in at least one of the first and second polymeric materials and an effective orientation axis along the MD.

7. The method of claim 6, wherein the temperature of the film under the first processing conditions is greater than the temperature of the film under the second processing conditions.

8. The method of claim 6, wherein the temperature of the film in the first draw step is from 20-100° C. above the glass transition temperature of the at least one of the first and second polymers, and wherein the temperature of the film in the second draw step is from 10° C. below the glass transition temperature of at least one of the first and second polymers to 40° C. above the glass transition temperature of at least one of the first and second polymers.

9. The method of claim 6, wherein the film is stretched along the MD direction in the first draw step.

10. The method of claim 6, further comprising drawing the film in a third draw step along the downweb (MD) direction under a third set of processing conditions.

11. The method of claim 6, wherein birefringence of the created in the first draw step is less than 0.05 and birefringence created in the second drawing step is at least 0.06.

12. The method of claim 6, wherein the film includes a layer comprising an absorbing polarizer material.

13. The method of claim 6, wherein subsequent the first and second draw steps the film is a reflective polarizer film.

14. A method of making an optical film, comprising:
providing a first film comprising at least a first polymeric material and a second polymeric material,
drawing the first film in a first draw step along a crossweb (TD) direction to widen the first film under a first set of processing conditions such that low in-plane birefringence is created in the first and second polymeric materials along the TD direction,
drawing the first film in a second draw step along a downweb (MD) direction under a second set of processing conditions to create in plane birefringence in at least one of the first and second polymeric materials; and
attaching a second film to the first optical film.

15. The method of claim 14, wherein the second film is attached to the first film following the first and second draw steps.

16. The method of claim 15, wherein the second film is selected from the group consisting of structured surface films, retarders, absorbing polarizing films and a combination thereof.

17. The method of claim 14, wherein attaching the second film to the first film comprises disposing an adhesive between the first film and the second film.

18. The method of claim 14, wherein the second film is coated on the first film.

19. The method of claim 18, wherein the second film comprises a curable material and attaching the second film further comprises structuring the curable material and curing the curable material to form a structured surface on the first film.

20. The method of claim 14, further comprising applying a surface treatment to the first film prior to attaching a second film to the first optical film.

21. The method of claim 20, wherein the surface treatment is selected from corona treatment, drying, applying a primer, or a combination thereof.

22. The method of claim 14, wherein subsequent the first and second draw steps the first film is a reflective polarizer film.
